(19) United States
(12) Patent Application Publication
(10) Pub. No.: US 2025/0132974 A1
(43) Pub. Date: Apr. 24, 2025

(54) SUBNET SORTING-BASED FAILOVER OF HIGH AVAILABILITY IP ADDRESSES ACROSS BROADCAST DOMAINS

(71) Applicant: Oracle International Corporation, Redwood Shores, CA (US)

(72) Inventors: Ming Zhu, Redwood City, CA (US); Balaji Pagadala, San Jose, CA (US)

(73) Assignee: Oracle International Corporation, Redwood Shores, CA (US)

(21) Appl. No.: 18/491,679

(22) Filed: Oct. 20, 2023

(51) Int. Cl. H04L 41/0663

(52) U.S. Cl. CPC H04L 41/0663

(57) ABSTRACT

Described is an improved approach to IP failover in a computing system. An approach is described which allows each node to perform its own sorted ordering of the interface devices on that node, but in a way where each node will deterministically come up with the exact same sorted order as another node. In this way, each node will select the exact same failover target as any other node, without requiring complicated coordination logic and without the need for a centralized coordinator.

### FIELD

This disclosure concerns a method, a computer program product, and a computer system for managing assignable IP addresses to devices in computer and/or data communication networks.

### BACKGROUND

In a computer and/or data communication network, each device connected to the network (e.g. via a “network adapter”) typically has its own, unique low level address, such as a manufacturer assigned Media Access Control Address (“MAC”) in the case of an Ethernet network. A network adapter's address is used to uniquely identify the network adapter in the network when sending data to the network adapter, or when receiving data from the network adapter. In a healthy network, no two network adapters have the same address. Data is typically transmitted in such networks in small bursts, often referred to as packets, frames, or cells, depending on the network origins and terminology.

Most network adapters also provide a software-definable address which is on top of the manufacturer-supplied address. These “soft” addresses are often used by systems to reorganize or optimize the addressing scheme within a local area network (“LAN”), or within a wide area network (“WAN”). Such software defined addresses are referred to as Locally Administered Addresses (“LAA”) in the Ethernet paradigm.

In a high availability IP address system, the soft address (in the form of an IP address) may be assigned to different network adaptors (e.g., network interface cards or “NICs”) to facilitate high availability for the computing node. To explain, consider if a computing node has two different network adaptors on that node (e.g., NIC 1 and NIC 2). An IP address (e.g., a “virtual” IP address) may be initially assigned to work in conjunction with NIC 1. However, consider if an error now occurs for NIC 1. In this situation, any workload that involves the IP address may not be capable of proceeding with its work since communications interruptions would occur with respect to the entity (e.g., a service using the IP address) associated with the NIC 1. To address this scenario, a “failover” process may be implemented to move the IP address from NIC 1 to NIC 2. By binding the IP address to the second NIC 2, this allows the service associated with the IP address to continue to be operational even in the event of a failure of the original NIC 1 that was assigned to the IP address.

It is noted that care must be taken when performing failover of soft addresses to avoid assigning the soft addresses in a manner that conflicts with subnet ranges associated with specific broadcast domains. This is because the node will need to communicate with other nodes that also have multiple NICs, where those multiple NICs are already associated with specific broadcast domains. If the IP address failover on the first node is not correctly coordinated with similar failover NIC-related failover steps on the other nodes, then a mismatch may occur between the specific NIC and broadcast domain combination on the first node relative to a corresponding NIC and broadcast domain combination on another node.

However, such coordination may require extensive IP address management logic, which may also require the hands-on involvement of a network engineer to perform the coordination. This process is not only very expensive in terms of infrastructure cost and complexity, but also is very prone to errors to the requirement to involve human/admin labor to coordinate the IP address transfer.

Therefore, there is a need for an improved method and/or system for performing IP address failovers across multiple broadcast domains within a computing network system.

### SUMMARY

According to some embodiments, described are improved systems, computer program products, and methods performing IP address failovers across multiple broadcast domains.

Further details of aspects, objects and advantages of the disclosure are described below in the detailed description, drawings and claims. Both the foregoing general description and the following detailed description are exemplary and explanatory, and are not intended to be limiting as to the scope of the disclosure.

### BRIEF DESCRIPTION OF FIGURES

The drawings illustrate the design and utility of some embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the disclosure, a more detailed description of the present disclosure briefly described above will be rendered by reference to specific embodiments thereof, which are illustrated in the accompanying drawings. Understanding that these drawings depict only typical embodiments of the disclosure and are not therefore to be considered limiting of its scope.

The drawings use like reference numerals to identify like elements. A letter after a reference numeral, such as “120a,” indicates that the text refers specifically to the element having that particular reference numeral. A reference numeral in the text without a following letter, such as “120,” refers to any or all of the elements in the drawings bearing that reference numeral (e.g. “120” in the text refers to reference numerals “120a” and/or “120b” in the drawings). The disclosure will be described and explained with additional specificity and detail through the use of the accompanying drawings in which:

FIG. 1A illustrates a computing network system having multiple computing devices.

FIG. 1B illustrates a failover that crosses multiple broadcast domains.

FIGS. 1C and 1D illustrate failovers that are consistent across multiple broadcast domains.

FIG. 2 shows a high-level flowchart of an approach to implement some embodiments of the invention.

FIG. 3 shows a more detailed flowchart of actions that may be taken as illustrative “setup” steps to prepare for a failover event.

FIG. 4 shows a more detailed flowchart of an approach to implement a failover according to some embodiments of the invention.

FIGS. 5A-F provide an illustrative example of an embodiment of the invention when performing a failover.

FIG. 6 shows a flowchart of this approach according to some embodiments of the invention.

FIGS. 7A-J provide an illustrative example of an embodiment of the invention when performing a failover with multiple factors.

FIG. 8 is a block diagram of an illustrative computing system suitable for implementing an embodiment of the present disclosure.

FIG. 9 is a block diagram of one or more components of a system environment by which services provided by one or more components of an embodiment system may be offered as cloud services, in accordance with an embodiment of the present disclosure.

### DETAILED DESCRIPTION

Various embodiments will now be described in detail, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components (or methods or processes), only those portions of such known components (or methods or processes) that are necessary for an understanding of the present disclosure will be described, and the detailed descriptions of other portions of such known components (or methods or processes) will be omitted so as not to obscure the disclosure. Further, various embodiments encompass present and future known equivalents to the components referred to herein by way of illustration.

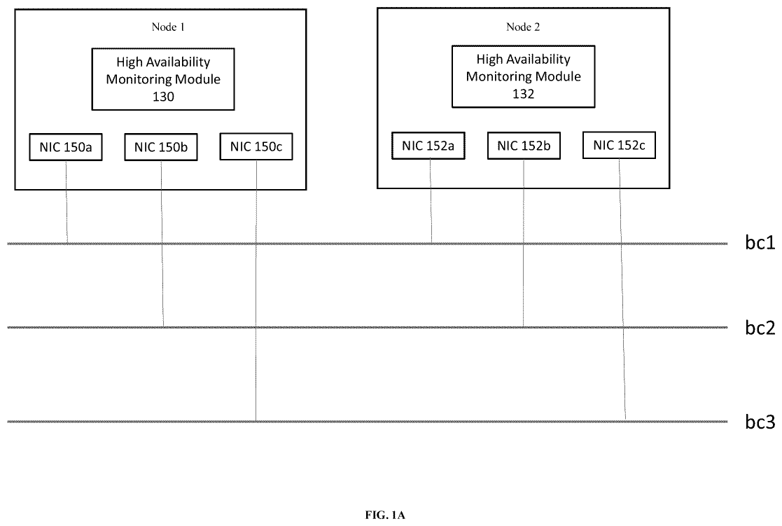

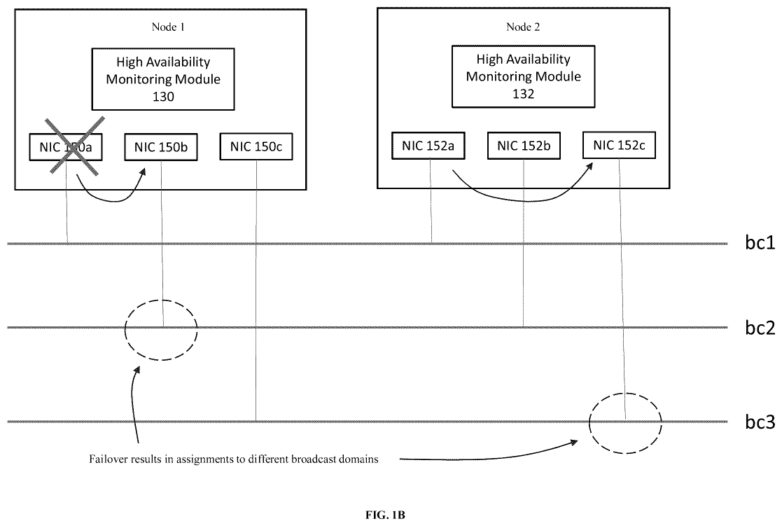

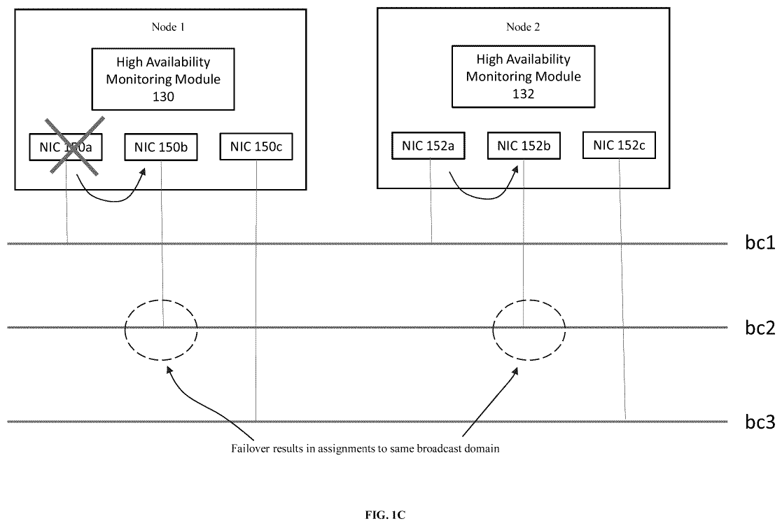

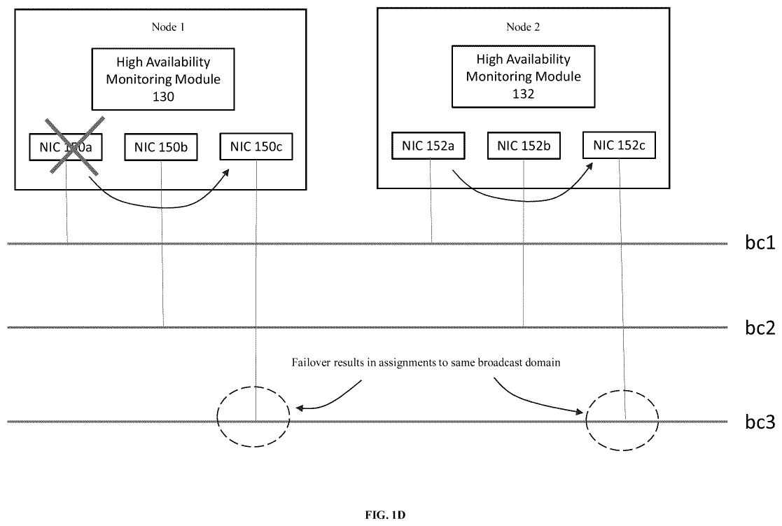

FIG. 1A illustrates a computing network system having multiple computing devices (Node 1 and Node 2). Each of the multiple computing devices may be a computer, a workstation, a server, a networking computer, or any computing equipment that communicates with another computing device over a network. Each of the computing devices may be configured with a plurality of network adapters to communicate with one another.

A network adapter is a component of a computer's hardware that is used for communicating over a network with another computer. A computer may connect with another computer, server or any networking device over a LAN and/or WAN connection using a network adapter. One type of network adapter is a network interface card (NIC). A NIC provides a computer with a dedicated, full-time connection to a network by implementing the physical layer circuitry necessary for communicating with a data link layer standard, such as Ethernet or Wi-Fi. Here, Node 1 includes a first NIC 150a, a second NIC 150b, and a third NIC 150c. Similarly, Node 2 includes a first NIC 152a, a second NIC 152b, and a third NIC 152c.

Each card represents a device and can prepare, transmit and control the flow of data on the network. The NIC uses the Open Systems Interconnection (OSI) model to send signals at the physical layer, transmit data packets at the network layer and operate as an interface at the TCP/IP layer. The term network interface card may be used interchangeably with the terms network interface controller, network adapter and LAN adapter in the present disclosure. A network adapter can be used over a wired or wireless network.

One common type of network for communicatively coupling computing devices to one another is the Ethernet network. In an Ethernet based network, an IP address may be assigned to a NIC within the network so that messages sent from one computer to another computer may be directed to the appropriate destination computer and vice versa.

The NICs may each be associated with a given broadcast domain. A broadcast domain is a logical division of a computer network in which all nodes (e.g., physical servers, computing devices, etc.) within a broadcast domain can reach each other by broadcast communication messages sent at a data link layer. A broadcast domain can be within a same local area network (“LAN”) segment or a broadcast domain can be bridged to other LAN segments. Any computer connected to a same Ethernet repeater or switch is a member of the same broadcast domain. Further, any computer connected to the same set of inter-connected switches/repeaters is a member of the same broadcast domain. Routers and other higher-layer devices form boundaries between broadcast domains.

In the current example of FIG. 1A, NIC 150a on Node 1 and NIC 152a on Node 2 are both associated with the same broadcast domain bc1. What this means is that these NICs are both associated with the same subnet range, and can communicate with each other using broadcast communication messages sent at a data link layer. Similarly, NIC 150b on Node 1 and NIC 152b on Node 2 are both associated with the same broadcast domain bc2, NIC 150c on Node 1 and NIC 152c on Node 2 are both associated with the same broadcast domain bc3, and these NICs at the same broadcast domains can likewise communicate with each other with broadcast messages at the data link layer.

In a high availability computing environment, each node may include a high availability monitoring module to implement a HAIP (high availability IP) protocol. In FIG. 1A, Node 1 includes a high availability monitoring module 130 and Node 2 includes a high availability monitoring module 132. The high availability monitoring module comprises an event manager that receives events (e.g., electronic communications), from modules within the node when an error is detected that may require handling to provide availability of the resources on the node. For example, a DLM (distributed lock manager) may exist on the node to implement database processing. If an error is detected by the DLM, then the DLM may send an event with a particular event type to the high availability monitoring module for inspection and/or resolution. In some embodiments, the high availability monitoring module integrates an early issue detection functionality of the DLM with the OS/network level of monitoring of a network handler to provide the ability to resolve and remediate certain types of communication issues between the nodes of the database.

Based on an event type of an event received from the DLM, the high availability monitoring module may instruct a network handler to resolve, as an example, a network communication error identified by the DLM by checking statuses of the NICs. A NIC, as discussed above, is a circuit board or card that is installed in a computer so that the computer can be connected to a network. A NIC provides the computer with a dedicated, full-time connection to a network. Communications between the nodes of the database are transmitted via the NICs on each respective node via a private network. A node may include a plurality of NICs such that a first set of the NICs may be dedicated to the database communications and a second set of NICs may be dedicated to other processes running on node (e.g., public network for applications to interact with, as an example, the Internet).

By way of example, consider when a DLM suspects a potential error may have occurred. For example, consider when a DLM issues a lock request to another node. If the DLM on the first node does not receive any acknowledgement from the other node for a threshold amount of time, then this type of failed processing of the DLM becomes an identified error. One type of action that may be taken to resolve this error is to perform an automatic eviction of the non-acknowledging node from the database cluster. However, this type of resolution is extremely severe and draconian, especially if the only error associated with the node is the failure of a NIC card on the node, rather than any other more serious problem. In this situation, it may be more efficient to perform a failover from a first NIC to a second NIC. This type of failover may be achieved by floating a virtual IP address from the first NIC to the second NIC. If failing over to a second NIC resolves the issue, then the failover is considered a successful avoidance of a potential eviction process.

Care must be taken when performing failover of IP addresses to avoid any conflicts with subnet ranges associated with specific broadcast domains. This is because the node will need to communicate with other nodes that also have multiple NICs, where those multiple NICs are already associated with specific broadcast domains.

To explain a potential problem to be avoided, consider if an error is detected with respect to communications by NIC 150a on Node 1 as shown in FIG. 1B. In this situation, when an error is identified for NIC 150a, the high availability monitoring module 130 on Node 1 may decide that the virtual IP address currently associated with NIC 150a needs to be failed over to NIC 150b. The previous NIC 150a is associated with broadcast domain bc1 and the new failover NIC 150b is associated with broadcast domain bc2. What this means is that, after the failover, the IP address being failed over, which used to be associated with broadcast domain bc1, will now be associated with broadcast domain bc2.

The issue is that to maintain the correct communications profile after the failover, every other address associated with other NICs on other nodes that corresponds to the same broadcast domain will also need to be failed over in the same corresponding way. Otherwise, a mismatch will occur after the failover. This is especially problematic if a first service or entity on a first node is now in a different broadcast domain and/or subnet from a second service or entity on a second node, and the relationship between the two entities/services is somehow reliant upon them being in the same broadcast domain and/or subnet. For example, if the two services/entities are within the same computing cluster, then depending upon how the cluster is configured, this situation may create problems in allowing both to be active within the same cluster, and/or access/form a common database or common storage infrastructure within the cluster.

To explain, consider again the failover scenario in FIG. 1B, where a failover process occurs on the second Node 2. Failover processing must also occur on the second node since, on the first Node 1, the failover has caused the IP address to no longer communicate on broadcast domain bc1. Therefore, the second Node 2 will also occur to cause a failover such that the pertinent address(es) are failed over to another broadcast domain. However, if the proper coordination is not performed, then it is possible that on the second Node 2, failover has occurred from NIC 152a to NIC 152c. This results in the address being moved to a NIC 150c that on a broadcast domain bc3, which is different from the broadcast domain bc2 for which the failover has occurred on Node 1. This example illustrates that if the IP address failover on the first node is not correctly coordinated with similar failover NIC-related failover steps on the other nodes, then a mismatch may occur between the specific NIC and broadcast domain combination on the first node relative to a corresponding NIC and broadcast domain combination on another node.

In a cluster or cloud, a floating-IP failover (to a different broadcast domain) may or may not guarantee it is routable after the failover. It depends on their global network topology, and it needs a network administrator to understand the topology and insert the needed route. Therefore, non-optimal solutions may require extensive IP address management logic, which may also require the hands-on involvement of a network engineer to perform the coordination. This process is not only very expensive in terms of infrastructure cost and complexity, but also is very prone to errors due to the requirement to involve human/admin labor to coordinate the IP address transfer.

However, embodiments of the invention resolve this situation in a very efficient manner, without the needs for expensive IP management logic. Instead, embodiments of the present invention operate by allowing each node to perform its own sorted ordering of the NICs on that node, but in a way where each node will deterministically come up with the exact same sorted order as another node. In this way, each node will select the exact same failover NIC as any other node, without requiring complicated coordination logic and without the need for a centralized coordinator. This results in either the solution of FIG. 1C or 1D, where as shown in FIG. 1C, the failover on all nodes occurs to the NICs associated with the same broadcast domain bc2, or as shown in FIG. 1D where the failover occurs on all nodes to the NICs associated with the same broadcast domain bc3.

To ensure the IP is still reachable by its peers automatically after a failover, the failover approach of the present embodiments is based on a specific IP assignment algorithm that is known by every node, e.g., which sorts a NIC list by an agreed-upon algorithm. In this way, regardless of failover/failback or node reboot or NIC up/down, at any moment, this will always ensure the floating-IP subnet range matches with its broadcast domain and then leads to a clean routing table of the floating-IP on each node in a multiple broadcast domain cluster or a cloud environment. By applying this approach, the system can ensure a cluster-wide software upgrade or downgrade should not hit any IP unreachable issues, even in a strict extended-cluster environments. This approach also dramatically improves reachability, especially in an asymmetric network environment.

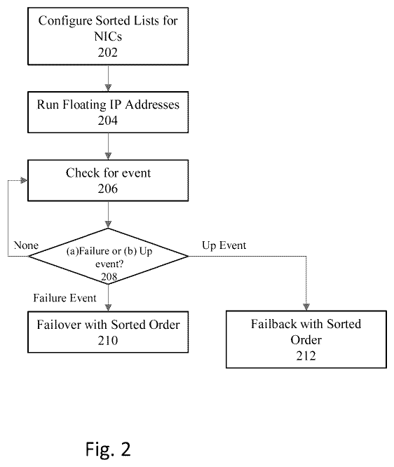

FIG. 2 shows a high-level flowchart of an approach to implement some embodiments of the invention. At 202, sorted lists of the NICS are configured ahead of time. As previously noted, the IP sorting/assignment algorithm is known and agreed upon by every node. For example, in one embodiment, the sorting algorithm sorts a NIC list using an IP assignment algorithm which sorts a NIC list by its NIC private-IP subnet internally associated with its broadcast domain. This approach would assign a lower subnet IP from the ascending sorted NIC list, as described in more detail below.

At 204, floating IP addresses are then run within the system, e.g., where the floating IP addresses are assigned to entities and/or services within the system and are bound to NICs on the nodes. A floating or virtual IP address that is configured and residing on a host is an IP address that applications on the host can use for communications, where virtual IP addressing can remove constraints associated with a fixed IP address. The “floating” or “virtual” nature of these addresses enables the ability to host multiple IP addresses on the server with a single NIC. Multiple NICs can also be used to host multiple IP addresses on the server. The use of these addresses has two main advantages over physical addressing: availability and mobility. If a virtual IP address is defined on a host with more than one physical NIC, it can communicate to a remote peer node through the unique virtual IP address using any of the physical NICs. In other words, virtual IP addressing provides application-level transparency. These advantages are generally used for Virtual Private Networks (VPNs), Quality of Service (QOS), and Link failover.

At 206, a check is made for an event of interest for the high availability IP system. As noted at 208, such an event may be either (a) a failure event of a type that may cause a failover to occur; or (b) an up event that may cause a failback to occur. Examples of a type of event which may cause a failover to occur includes, for instance, communications failure events such as events that may correspond to the failure of a NIC device. Examples of a type of event which may cause a failback to occur includes, for instance, the restoration of function to a NIC device that was previously the subject of a failure event.

If an appropriate failure event is detected, then at 210, a failover is performed with the embodiments of the invention using the sorted ordering between nodes. If an appropriate up event is detected, then at 212, a failback is performed with the embodiments of the invention which may also use sorted ordering for the failback. If no appropriate event is detected, then the process may return back to 206 to await further events.

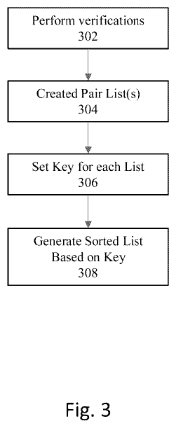

FIG. 3 shows a more detailed flowchart of actions that may be taken as illustrative “setup” steps to prepare for a failover event. At 302, certain verifications are made with respect to the NICs. For example, these verification actions may include the verification of the correctness for specifically identified interface names. Another verification might be to ensure that broadcast domains are linked with its private interface subnet. This may be performed by pinging the remote peers via different interfaces.

Next, at 304, pair lists are created for the interfaces. In some embodiments, this action is taken to create a pair list of each pair with the interface name and subnet of all monitored network interfaces on a node.

At 306, a “key” is set for each list. The key value corresponds to the specific value within the list tuple that will be used to sort the list. In some embodiment, the subnet number is set as a key of each pair.

At 308, a sorted list is generated using the key values. Any type of sorting may be applied to sort the list, e.g., using either an ascending ordering or a descending ordering. The most important factor is that there is a predefined order that is consistent across all of the nodes. In a current embodiment, the pair list is sorted based on the key in an ascending order.

Afterwards, each floating IP address is generated accordingly with incremental subnet partitioning numbers. The address will also be attached to the next interface in the sorted list. Subsequently, assume that the IP addresses are thereafter up and running when entering the next process flow to perform a failover.

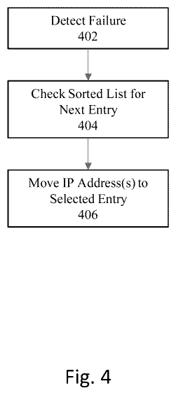

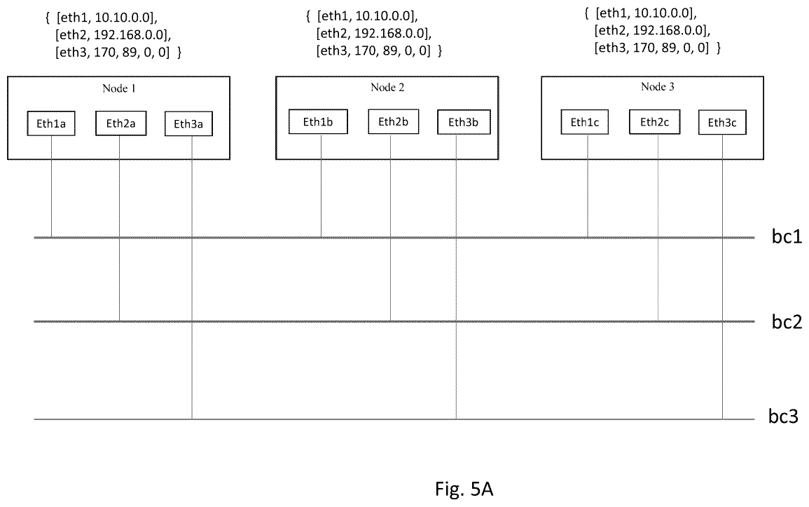

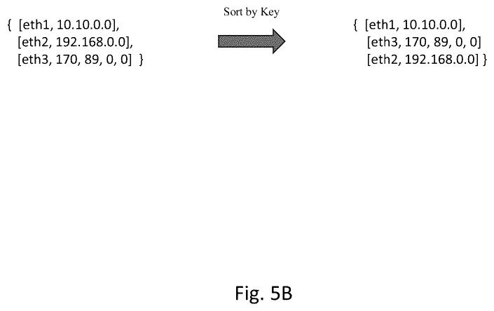

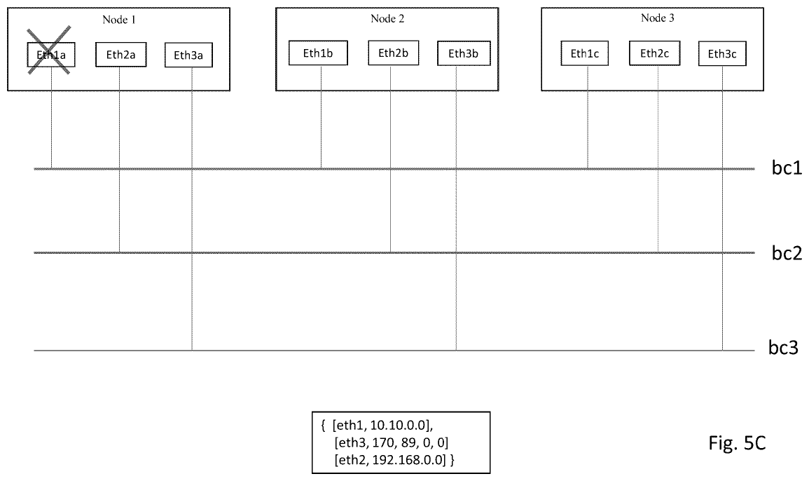

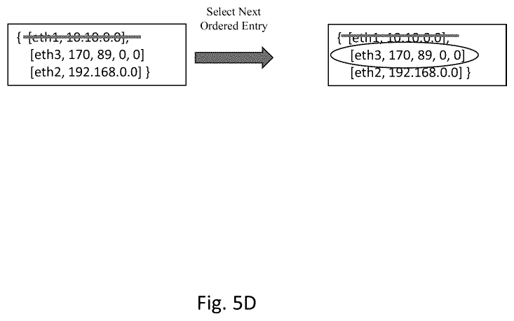

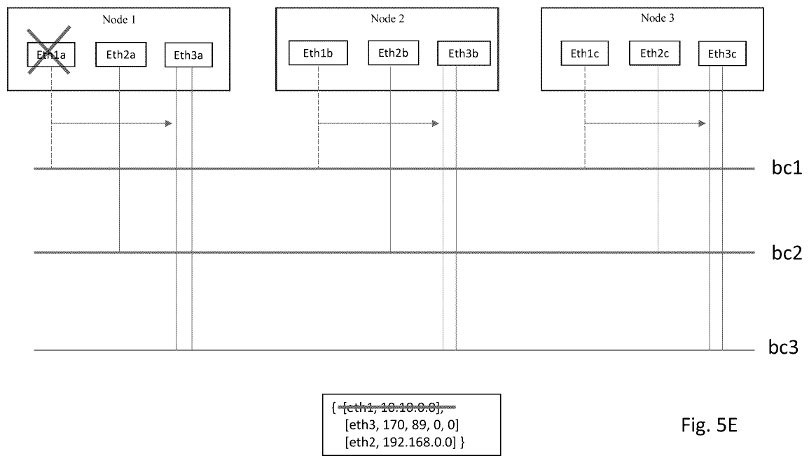

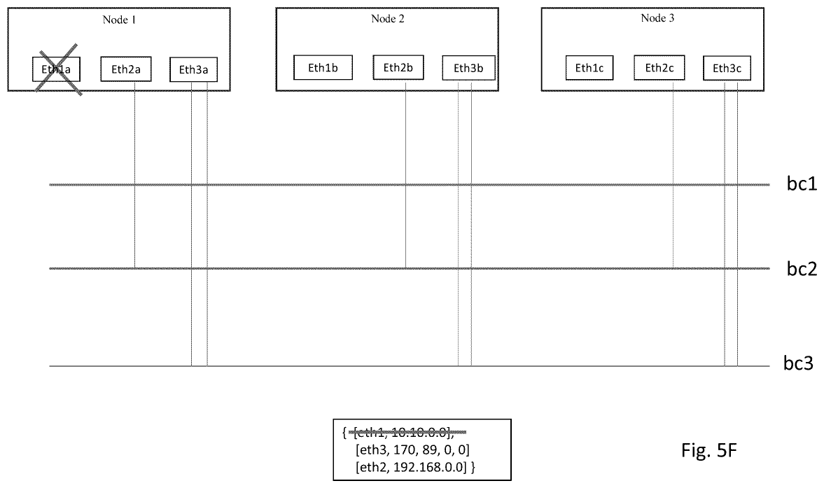

FIG. 4 shows a more detailed flowchart of an approach to implement a failover according to some embodiments of the invention. At 402, a network interface “down” event is detected. If so, then at 404, the system will select the next available network interface in the sorted list. Thereafter, 406, the system will move the IP address which is attached to the ‘down’ network interface to the just-picked network interface. Similar processing is performed to implement a failback for the occurrence of an up event.

FIGS. 5A-F provide an illustrative example of an embodiment of the invention when performing a failover. FIG. 5A shows multiple computing devices Node 1, Node 2, and Node 3. Each of the nodes includes multiple network adaptors. Here, Node 1 includes a first NIC Eth1a, a second NIC Eth2a, and a third NIC Eth3a. Similarly, Node 2 includes a first NIC Eth1b, a second NIC Eth2b, and a third NIC Eth3b. Node 3 includes a first NIC Eth1c, a second NIC Eth2c, and a third NIC Eth3c.

The NICs may each be associated with a given broadcast domain. In the current example of FIG. 5A, the first NIC on each node (Eth1a on Node 1 and Eth1b on Node 2, and Eth1c on Node 3) will be associated with broadcast domain bc1. The second NIC on each node (Eth2a on Node 1, Eth2b on Node 2 and Eth2c on Node 3) will be associated with broadcast domain bc2. The third NIC on each node (Eth3a on Node 1, Eth3b on Node 2 and Eth3c on Node 3) will be associated with broadcast domain bc3.

A pair list is generated for the network adaptors on the nodes. Each entry in the pair list will include the following information: “[adapter name, subnet]”. The list will include an entry for each of the adaptors. In the current example, the subnet for Eth1 is “10.10.0.0”. Therefore, the pair entry for Eth1 is “[Eth1, 10.10.0.0]”. In the example in the figure, the subnet for Eth2 is “192.169.0.0”. Therefore, the pair entry for Eth1 is “[Eth2, 192.169.0.0]”. For Eth3, the subnet for this in the example is “170.89.0.0”. Therefore, the pair entry for Eth1 is “[Eth3, 170.89.0.0]”. The entire pair list would include all three of these entries.

As shown in FIG. 5B, sorting can be performed on the pair list. The sorting will be based upon the key value within the entries. Here, the key value is the subnet value. In the current example, an ascending order is implemented for the sorted list based upon the key values. In this example, the original list may have an order of (1) Eth1, (2) Eth2, and (3) Eth3. However, once sorting is performed on the subnet value, it can be seen that the subnet value for Eth3 is smaller than for Eth2. Therefore, the newly sorted order for the paid list, in an ascending order, will now be: (1) Eth1; (2) Eth3; (3) Eth2.

Consider if a failure event is detected for one of the network adaptors. FIG. 5C shows an illustrative situation where adaptor Eth1a on Node 1 has now failed. In this situation, a failover will occur for an IP address that was previously associated with Eth1a. The question that needs to be answered is which of the other adaptors should be the new destination for the failover IP address.

FIG. 5D shows the selection process that is engaged by every node to implement the failover. Here, as shown on the left-hand side of the figure, the Eth1 entry is now identified as a down adaptor. Assume that the selection process is to select the next adaptor in an ascending order. In this situation, the next adaptor to be selected in the ascending order is the Eth3 adaptor. Here, this means that Eth3 on each node is selected as the failover destination.

Therefore, as shown in FIG. 5E, each of the nodes will engage in the exact same coordinated and consistent failover action, where the failover will bind the IP address failover from source Eth1 to target Eth3. The final result is shown in FIG. 5F, where it can be seen that multiple ones of the floating IP addresses are now bound to Eth3 (and on the same broadcast domain bc3) on each node.

In some embodiments, when engaging in the failover/failback process, additional one or more factors may be analyzed to determine the selection of a failover/failback targets. For example, load levels may be considered when deciding whether to select a failover or failback target.

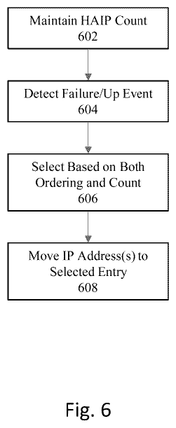

FIG. 6 shows a flowchart of this approach according to some embodiments of the invention. At 602, a HAIP count is maintained for the nodes within the system. This count can be used to track the load on each node, e.g., to track the failovers that have occurred to each HAIP domain as a failover target.

At 604, a failover or failback related event is detected. For failover, this includes for instance, a failure event that may have occurred to an interface device on a node. For failback, this includes for instance, an up event for a previously failed interface device.

At 606, a selection of the failover/failback target is selected based on multiple factors, such as considering both load and ordering. For example, in some embodiments, multiple levels of selectin criteria are used, where a first level of criteria may be the load level of the nodes, and a second level of criteria is the next node in either the ascending or descending order. Thereafter, at 608, the IP address is moved to the selected failover or failback target.

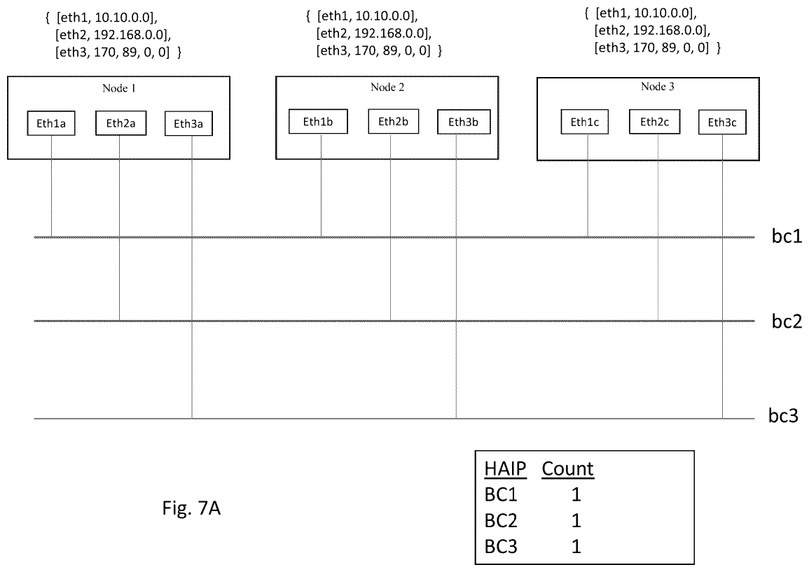

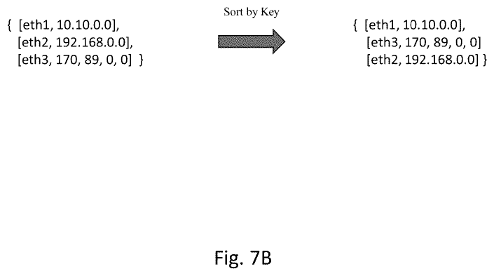

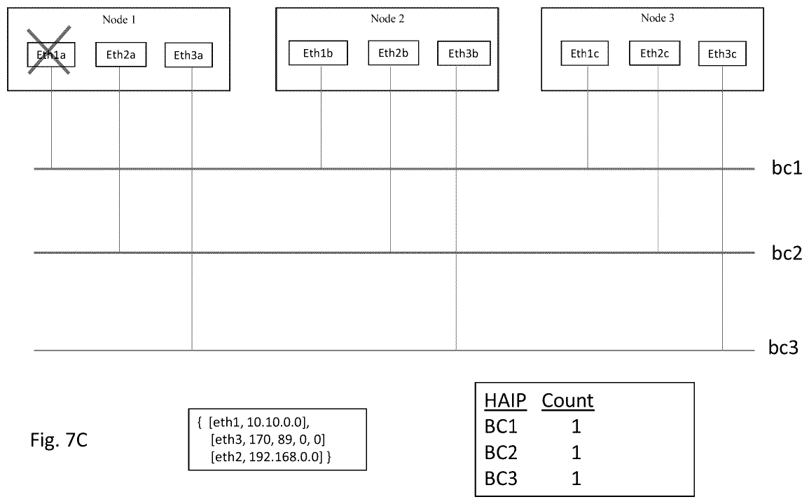

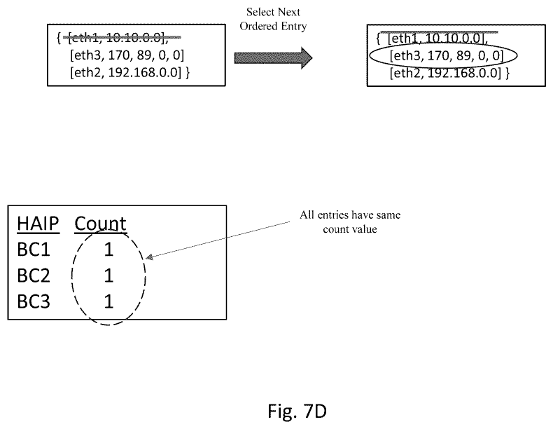

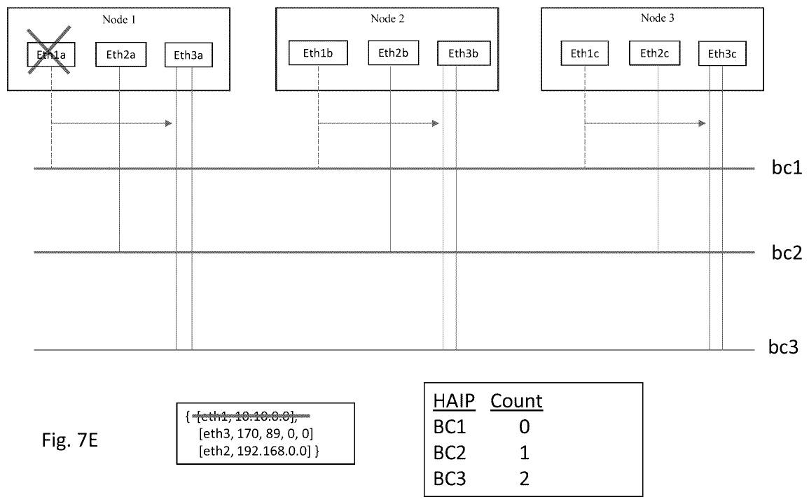

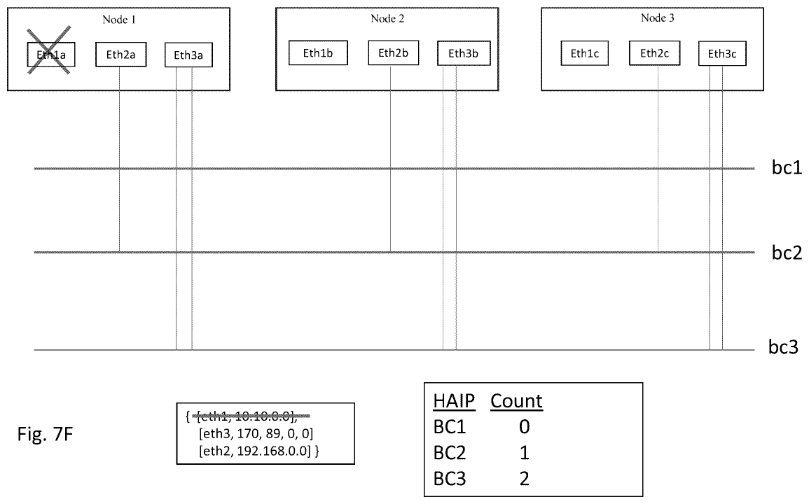

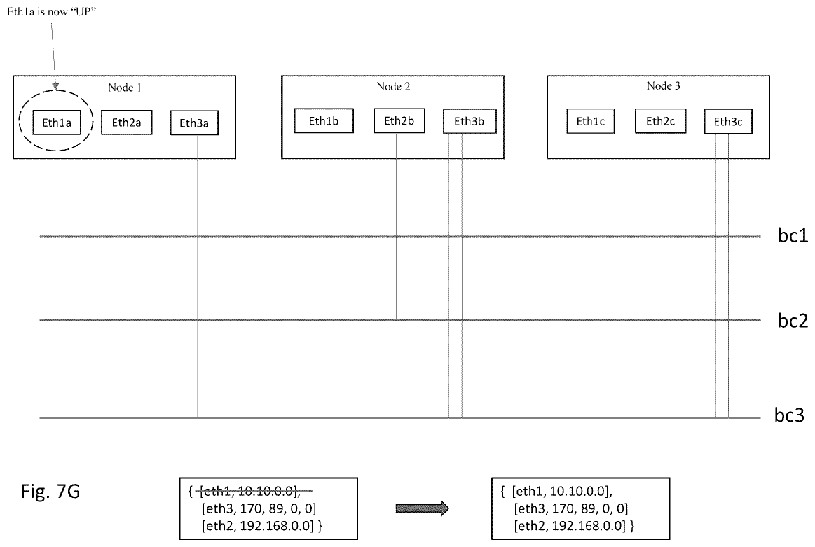

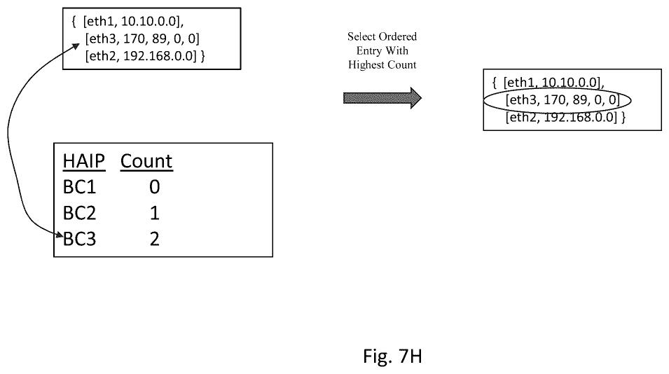

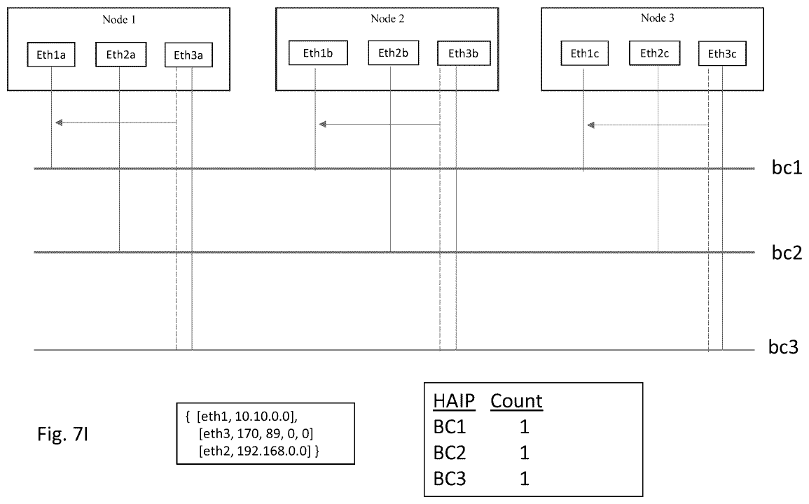

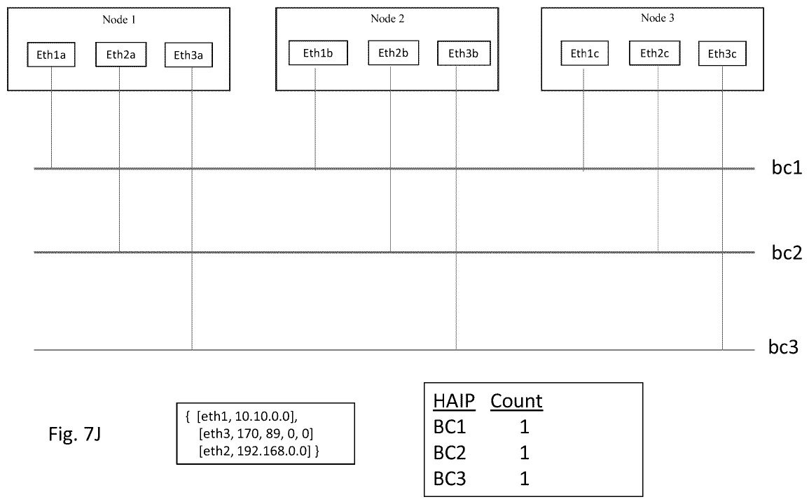

FIGS. 7A-J provide an illustrative example of an embodiment of the invention when performing a failover with multiple factors. As before, FIG. 7A shows multiple computing devices Node 1, Node 2, and Node 3. Each of the nodes includes multiple network adaptors. Here, Node 1 includes a first NIC Eth1a, a second NIC Eth2a, and a third NIC Eth3a. Similarly, Node 2 includes a first NIC Eth1b, a second NIC Eth2b, and a third NIC Eth3b. Node 3 includes a first NIC Eth1c, a second NIC Eth2c, and a third NIC Eth3c. The NICs may each be associated with a given broadcast domain. In the current example of FIG. 5A, the first NIC on each node (Eth1a on Node 1 and Eth1b on Nodes 2, and Eth1c on Node 3) will be associated with broadcast domain bc1. The second NIC on each node (Eth2a on Node 1, Eth2b on Node 2 and Eth2c on Node 3) will be associated with broadcast domain bc2. The third NIC on each node (Eth3a on Node 1, Eth3b on Node 2 and Eth3c on Node 3) will be associated with broadcast domain bc3. A pair list is generated for the network adaptors on the nodes. Each entry in the pair list will include the following information: “[adapter name, subnet]”. The list will include an entry for each of the adaptors. In the current example, the subnet for Eth1 is “10.10.0.0”. Therefore, the pair entry for Eth1 is “[Eth1, 10.10.0.0]”. In the example in the figure, the subnet for Eth2 is “192.169.0.0”. Therefore, the pair entry for Eth1 is “[Eth2, 192.169.0.0]”. For Eth3, the subnet for this in the example is “170.89.0.0”. Therefore, the pair entry for Eth1 is “[Eth3, 170.89.0.0]”. The entire pair list would include all three of these entries.

In addition, an HAIP count table is also maintained. In the current embodiment, each entry in the HAIP count table identifies a given broadcast domain, along with an HAIP count for that broadcast domain. For the example shown in the figure, since no failure events have yet been detected, the count for each broadcast domain is currently “1”.

FIG. 7B shows the sorting that can be performed on the pair list. In the current example, an ascending order is implemented for the sorted list based upon the key values. In this example, the original list may have an order of (1) Eth1, (2) Eth2, and (3) Eth3. Once sorting is performed on the subnet value, it can be seen that the subnet value for Eth3 is smaller than for Eth2. Therefore, the newly sorted order for the paid list, in an ascending order, will now be: (1) Eth1; (2) Eth3; (3) Eth2.

FIG. 7C shows the situation after a failure event is detected for one of the network adaptors, where adaptor Eth1a on Node 1 has now failed. In this situation, a failover will occur for an IP address that was previously associated with Eth1a.

FIG. 7D shows the selection process that is engaged by every node to implement the failover. Here, as shown on the left-hand side of the figure, the Eth1 entry is now identified as a down adaptor. Assume that the selection process for a failover is to first identify the HAIP having the lowest count. The general idea is that for a failover, the lowest count should be selected as the failover target to promote load balancing. In the current situation, all the HAIPs have the same count value. Therefore, the count value does not provide a selection winner. At this point, the next level of selection is performed to select the next adaptor in an ascending order. In this situation, the next adaptor to be selected in the ascending order is the Eth3 adaptor. Here, this means that Eth3 on each node is selected as the failover destination.

Therefore, as shown in FIG. 7E, each of the nodes will engage in the exact same coordinated and consistent failover action, where the failover will bind the IP address failover from source Eth1 to target Eth3. The HAIP count table will also be updated, which now shows bc3 having a count of “2”. FIG. 7F shows the situation after the failover processes have finished.

At some point in the future, Eth1a on node 1 may come back up. Therefore, as shown in FIG. 7G, and UP event may now be detected for Eth1a. Assume that this UP event now triggers failback processing.

FIG. 7H shows the selection process that is engaged by every node to implement the failback. Assume that the selection process is to first identify the HAIP having the highest count. The general idea is that for a failback, the highest count should be identified as the failback source to promote more even load balancing. In the current situation, the HAIP count table indicates that “bc3” has the highest count of “2”. Therefore, in this example, the count value provides a selection winner, where bc3 is selected as the failback source. Since a winner has now been selected, this means that a next level of selection does not need to occur for this example. Here, this means that Eth3 on each node is selected as the failback source. However, consider if there were multiple entries that have the same HAIP count. In this situation, a next level of selection is performed to select the next adaptor in an either the ascending or descending order.

As shown in FIG. 7I, each of the nodes will engage in the exact same coordinated and consistent failback action, where the failback will bind the IP address failback operation from source Eth3 to target Eth1. The HAIP count table will also be updated, which now shows all broadcast domains now having a count of “1”. The final result is shown in FIG. 7J.

Therefore, what has been described is an improved approach to implement failover for addresses in a high availability IP address system. The present invention provides a cost-effective and robust floating IP failover/failback mechanisms for high availability. This approach ensures that IP failovers will not cause IP reachability issues across multiple broadcast domains in an asymmetric network cluster or cloud environment. A sorting module is constructed and managed to assign floating-IP to a particular network interface card with an internally designed order. When floating-IP failovers happen, the module also decides which NIC the floating-IP should failover to and ensure the floating-IP is still reachable by its peers after the failover. This therefore eliminates unnecessary and complex failover and routing algorithms and guarantees a safe IP failover without any IP routing issue in a different broadcast domain. It is helpful for an extended cluster, a typical environment of multiple broadcast domains

### System Architecture Over View

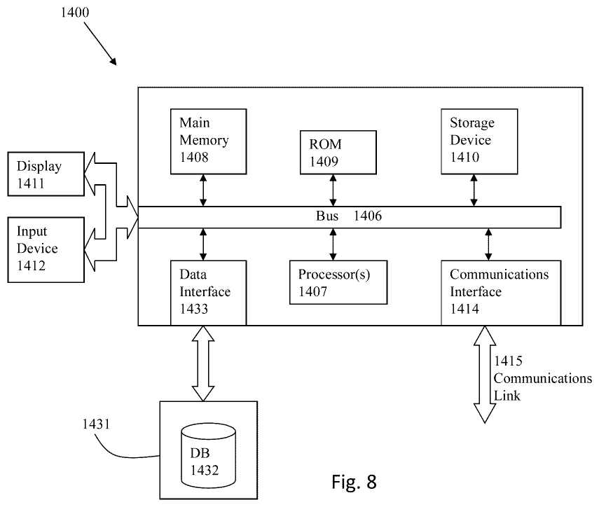

FIG. 8 is a block diagram of an illustrative computing system 1400 suitable for implementing an embodiment of the present disclosure. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), data interface 1433, and cursor control.

According to some embodiments of the disclosure, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the disclosure. Thus, embodiments of the disclosure are not limited to any specific combination of hardware circuitry and/or software. In some embodiments, the term “logic” shall mean any combination of software or hardware that is used to implement all or part of the disclosure.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the disclosure, execution of the sequences of instructions to practice the disclosure is performed by a single computer system 1400. According to other embodiments of the disclosure, two or more computer systems 1400 coupled by communication link 1410 (e.g., LAN, PTSN, or wireless network) may perform the sequence of instructions required to practice the disclosure in coordination with one another.

Computer system 1400 may transmit and receive messages, data, and instructions, including program, e.g., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400 via data interface 1433.

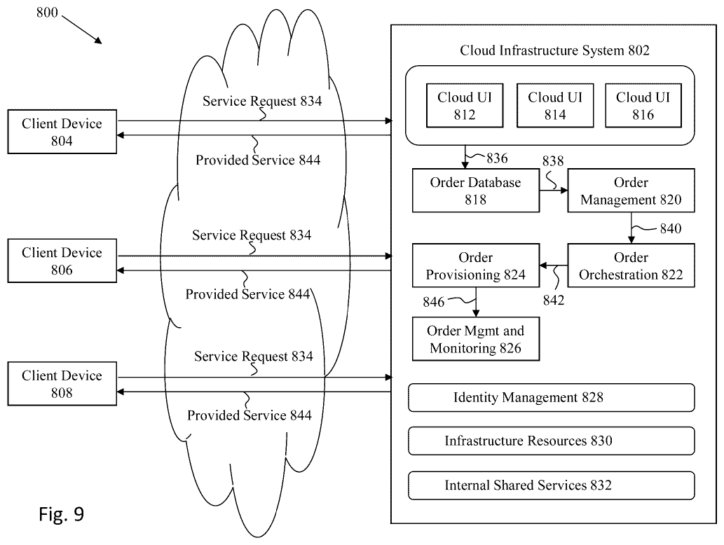

FIG. 9 is a simplified block diagram of one or more components of a system environment 800 by which services provided by one or more components of an embodiment system may be offered as cloud services, in accordance with an embodiment of the present disclosure. In the illustrated embodiment, system environment 800 includes one or more client computing devices 804, 806, and 808 that may be used by users to interact with a cloud infrastructure system 802 that provides cloud services. The client computing devices may be configured to operate a client application such as a web browser, a proprietary client application, or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the embodiment shown in the figure is only one example of a cloud infrastructure system that may incorporate an embodiment of the disclosure. In some other embodiments, cloud infrastructure system 802 may have more or fewer components than shown in the figure, may combine two or more components, or may have a different configuration or arrangement of components. Client computing devices 804, 806, and 808 may be devices similar to those described above for FIG. 8. Although system environment 800 is shown with three client computing devices, any number of client computing devices may be supported. Other devices such as devices with sensors, etc. may interact with cloud infrastructure system 802.

Network(s) 810 may facilitate communications and exchange of data between clients 804, 806, and 808 and cloud infrastructure system 802. Each network may be any type of network familiar to those skilled in the art that can support data communications using any of a variety of commercially-available protocols. Cloud infrastructure system 802 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, elastically scalable, reliable, highly available, and secure manner.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that allow organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that allow organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users and dynamically re-allocated per demand. Additionally, resources may be allocated to users in different time zones. For example, cloud infrastructure system 830 may allow a first set of users in a first time zone to utilize resources of the cloud infrastructure system for a specified number of hours and then allow the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, specialized server computers, server farms, server clusters, or any other appropriate arrangement and/or combination.

In operation 834, a customer using a client device, such as client device 804, 806 or 808, may interact with cloud infrastructure system 802 by requesting one or more services provided by cloud infrastructure system 802 and placing an order for a subscription for one or more services offered by cloud infrastructure system 802. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816. At operation 836, the order is stored in order database 818. Order database 818 can be one of several databases operated by cloud infrastructure system 818 and operated in conjunction with other system elements. At operation 838, the order information is forwarded to an order management module 820. In some instances, order management module 820 may be configured to perform billing and accounting functions related to the order, such as verifying the order, and upon verification, booking the order. At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 allows the management of business processes associated with each order and applies business logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 allows the allocation of resources for the services ordered by the customer. Order provisioning module 824 provides a level of abstraction between the cloud services provided by cloud infrastructure system 802 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 802 may include an identity management module 828. Identity management module 828 may be configured to provide identity services, such as access management and authorization services in cloud infrastructure system 802. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

What is claimed is:

1. A computer-implemented method, comprising:
identifying a system having multiple nodes, wherein each of the multiple nodes comprises a plurality of network adaptors;
maintaining a sorted list of the plurality of network adaptors on each of the multiple nodes;
identifying a failover or failback event for the plurality of network adaptors; and
performing failover or failback on each of the nodes using the sorted list of the plurality of network adaptors.

2. The method of claim 1, wherein the plurality of network adaptors comprises network interface cards (NICs), and the sorted list comprises a sorted list of the NICs.

3. The method of claim 1, wherein the sorted list is formed as sorted pair lists, wherein an entry in the pair list comprises a tuple having an interface identifier and a subnet value.

4. The method of claim 3, wherein a key is identified for the pair list, the key corresponds to the subnet value, and sorting is performed on the subnet value for the key.

5. The method of claim 1, wherein failover or the failback is performed in an ascending or descending order within the sorted list.

6. The method of claim 1, wherein a load level is considered when selecting a target or source for the failover or failback.

7. The method of claim 6, wherein an IP count is maintained for the load level, and the IP count is considered when selecting the target or the source for the failover or failback.

8. A computer program product embodied on a computer readable medium, the computer readable medium having stored thereon a sequence of instructions which, when executed by a processor, executes:
identifying a system having multiple nodes, wherein each of the multiple nodes comprises a plurality of network adaptors;
maintaining a sorted list of the plurality of network adaptors on each of the multiple nodes;
identifying a failover or failback event for the plurality of network adaptors; and
performing failover or failback on each of the nodes using the sorted list of the plurality of network adaptors.

9. The computer program product of claim 8, wherein the plurality of network adaptors comprises network interface cards (NICs), and the sorted list comprises a sorted list of the NICs.

10. The computer program product of claim 8, wherein the sorted list is formed as sorted pair lists, wherein an entry in the pair list comprises a tuple having an interface identifier and a subnet value.

11. The computer program product of claim 10, wherein a key is identified for the pair list, the key corresponds to the subnet value, and sorting is performed on the subnet value for the key.

12. The computer program product of claim 8, wherein failover or the failback is performed in an ascending or descending order within the sorted list.

13. The computer program product of claim 8, wherein a load level is considered when selecting a target or source for the failover or failback.

14. The computer program product of claim 13, wherein an IP count is maintained for the load level, and the IP count is considered when selecting the target or the source for the failover or failback.

15. The computer program product of claim 8, wherein the sequence of instructions is executable by the processor for a second node to receive a message from the first node regarding the IP address being generated for the first node in the first broadcast domain, and the sequence of instructions is further executable by the processor for the second node to cross-check the IP address within a shared data structure at the second node to identify whether the IP address is assigned to an entity at the second node associated with the second broadcast domain.

16. A system, comprising:
a processor;
a memory for holding programmable code; and
wherein the programmable code includes instructions for identifying a system having multiple nodes, wherein each of the multiple nodes comprises a plurality of network adaptors; maintaining a sorted list of the plurality of network adaptors on each of the multiple nodes; identifying a failover or failback event for the plurality of network adaptors; and performing failover or failback on each of the nodes using the sorted list of the plurality of network adaptors.

17. The met system hold of claim 16, wherein the plurality of network adaptors comprises network interface cards (NICs), and the sorted list comprises a sorted list of the NICs.

18. The system of claim 16, wherein the sorted list is formed as sorted pair lists, wherein an entry in the pair list comprises a tuple having an interface identifier and a subnet value.

19. The system of claim 18, wherein a key is identified for the pair list, the key corresponds to the subnet value, and sorting is performed on the subnet value for the key.

20. The system of claim 16, wherein failover or the failback is performed in an ascending or descending order within the sorted list.

21. The system of claim 16, wherein a load level is considered when selecting a target or source for the failover or failback.

22. The system of claim 21, wherein an IP count is maintained for the load level, and the IP count is considered when selecting the target or the source for the failover or failback.
